(19) United States
(12) Patent Application Publication
(10) Pub. No.: US 2005/0120003 A1
(43) Pub. Date: Jun. 2, 2005

(54) Method for maintaining a record of searches and results

(76) Inventors: William J. Drury, Sierra Madre, CA (US); Brian Despain, Las Vegas, NV (US); Andrei Maltsev, Arcadia, CA (US)

Correspondence Address: COUDERT BROTHERS LLP, 333 SOUTH HOPE STREET, 23RD FLOOR, LOS ANGELES, CA, 90071, US

(21) Appl. No.: 10/962,384

(22) Filed: Oct. 8, 2004

Related U.S. Application Data
(60) Provisional application No. 60/509,831, filed on Oct. 8, 2003.

(51) Int. Cl. G06F 7/00

(52) U.S. Cl. 707/3

(57) ABSTRACT

The invention is a method for storing searches and results on the Internet. A software solution allows a user to search the Internet in the conventional manner, and to click on links presented as a result from other search engines. The solution then remembers and stores in a search history all search strings typed, result pages viewed, and all external result links clicked on, along with the date and time on which these actions occurred. The history allows the user to examine all the steps of the search along with information from the links clicked on, or to view and edit the history in various ways. A user can manually add a listing to the history without having to search for or click on a particular listing. The relevancy of the search results can be adjusted based on the stored web pages in the profile of a user.

### CROSS-REFERENCE TO RELATED APPLICATION(S)

The present application claims the benefit of priority from pending U.S. Provisional Patent Application No. 60/509,831, entitled “A Method For Maintaining A Record Of Searches And Results”, filed Oct. 8, 2003, which is herein incorporated by reference in its entirety.

### BACKGROUND OF THE INVENTION

1. Field of the Invention

The present invention relates to the field of search engines, and in particular to a method for maintaining a record of searches and results.

Portions of the disclosure of this patent document contain material that are subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Search is a popular activity on the Internet, yet the way a user has interacted with a search engine has hardly changed from its conception. It is relatively easy to find information on almost every topic, but difficult to remember more than a handful of sites for any length of time. A user who is interested in more than one field often suffers a ‘loss of context’ when switching between subjects, and the existing tools do little to help the user to recreate his/her train of thought. Even during a single search session, it can be difficult to keep everything organized. Wading through multiple pages of listings and ads, and visiting multiple sites, many of which do not turn out to be useful after all, are common experiences for an Internet user.

Following links down several levels of a site, and through several sites in search of information, and then hitting the ‘back’ button several times to try to get back to the most relevant information page is also another annoyance. Instead of wasting time hitting the ‘back’ button and waiting as each previously discarded page tries to reload itself, a user will often return to the main page of the search engine site, try to recall the search string typed for the most relevant information page, and start the process all over again. If a user has done research at some time in the past, most of that effort must be expended again if the user wants to remember all of the information at some later time. Information about the process the user went through during the initial search session, including missteps, permutations, diversions, and unexpected connections and the date on which all of these occurred is almost completely lost.

There are prior art methods that try to organize the search results of a user and are discussed next.

Bookmarks

Bookmarks, or manually-created lists of website addresses, are tools that existed even before the onset of the Internet. Early, pre-web graphical and text-based catalog browsers often had such tools, and when the first web browser came along, it inherited this feature from them. If, while visiting a site in the midst of a search, a user determines that the site might be useful, the user can choose to bookmark it. But even moderate searchers soon experience ‘bookmark overload’, where an ever-growing, scrolling list is presented (usually in alphabetical, rather than chronological or topical order), which they must poke through to attempt to piece together a few artifacts they collected while they engaged in a search some time in the past.

Another handicap of the bookmarks is that if a user searches from multiple locations, such as from work and home, there is also the problem that some bookmarks are on one machine, and some on another. This results is the user emailing the links to him/her-self, or going back to the search engine to try to recreate a previous search session to re-find a site previously visited. A user may not fastidiously bookmark every site, or immediately sort the bookmarks into appropriately dated and categorized folders. Thus, a great deal of the process, context, and the effort expended searching is lost. Bookmarks require a constant and sometimes a conscious effort on the part of a user to maintain, and still do not manage to represent a user's train of thought during a particular search session. Bookmark systems insist that the user decides, in the middle of a search session and thus without complete information, whether or not the site being viewed is a useful answer to his/her query. Since no session-independent history is kept, there is no way to go back and review the steps of a search later in time.

Amazon.com

There are other search engines within certain sites that provide the feature of a session-independent history. One such site is www.amazon.com, which remembers which of their products were clicked by a user during a single session. However, there are many limitations of these search engines within the site, namely, the site does not display the search queries used to get to the products, or any other queries tried by the user. It does not seek, nor does it serve, to present the user with a complete overview of the path through their site, or any external links the user may have clicked that resulted in the user leaving their site and entering another site. It does not remember the products browsed by the user for more than a single visit. And of course, the search mechanism within a site like www.amazon.com is not a general search tool, but only a mechanism to search the local catalog of products, and is mostly intended to offer suggestions about other products sold by the site that the user might wish to buy.

### SUMMARY OF THE INVENTION

The present invention is a method for maintaining a record of searches and results on the Internet. According to one embodiment, the software solution of the present invention used to fix the handicaps of prior art solutions allow a user to search for information on the Internet in the conventional manner, and to click on links presented as a result from other search engines. The software solution also remembers all search strings typed, result pages viewed, and all the external result links clicked on, along with the date and time at which these actions occurred. A search history of recent searches and clicks is displayed to the user along with the traditional search interface. According to another embodiment of the present invention, there is a helper application built into the software solution which tracks user interactions with any application, any web browser, any system, and other software controls.

According to another embodiment of the present invention, a link to another page containing a more complete list of the user's search history is available, which allows the user to examine all the steps of a search along with information on all of the result links clicked on. On this page, the user is allowed to view and edit the list in various ways. According to one embodiment of the present invention, the user is offered a way to create an account on a system so that he/she may later re-visit a page or an entire site using the list of search history from the same or different computer and review the search behavior from previous sessions, or be able to add notes and ratings to each listing of a search history. According to another embodiment of the present invention, the user has the ability to publish some or all of his/her list of search history along with any notes or ratings attached to each listing in a way that is viewable by other users. According to another embodiment, some portion of a user's list of search history is viewable only by a specific group of other users, while the rest of the list is viewable by all users. According to another embodiment of the present invention, a user has the ability to block temporarily or permanently any listing within a search history. If a listing is permanently blocked then it will not be recorded in the list of search history in all subsequent Internet searches.

According to another embodiment of the present invention, a user can manually add listings to the history without having to search for or click on a particular listing. According to another embodiment, the list of search history is contained in a remote database to remain accessible to the user at any time. According to another embodiment of the present invention, there is a mechanism for storing individual web pages based on a user input. This information can be viewed by the user at a later time by logging into the system. According to another embodiment of the present invention, there is a mechanism that allows the user to search through this information. According to another embodiment of the present invention, the relevancy of the search results can be adjusted based on the stored web pages in the profile of a user.

### BRIEF DESCRIPTION OF THE DRAWINGS

These and other features, aspects and advantages of the present invention will become better understood with regard to the following description, appended claims and accompanying drawings where:

FIG. 1 is an illustration of a screen shot of contents, according to one embodiment of the present invention.

FIG. 2 is an illustration of a screen shot, according to another embodiment of the present invention.

FIG. 3 is an illustration of a screen shot, according to another embodiment of the present invention.

FIG. 4 is an illustration of a screen shot, according to another embodiment of the present invention.

FIG. 5 is an illustration of a user connection from two different machines, according to one embodiment of the present invention.

FIG. 6 is a block diagram, according to one embodiment of the present invention.

### DETAILED DESCRIPTION OF THE INVENTION

The embodiments of the present invention are directed to a method for maintaining a record of searches and results on the Internet. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

Software Solution

According to one embodiment, the software solution of the present invention used to fix the handicaps of prior art solutions allow a user to search for information on the Internet in the conventional manner, and to click on links presented as a result from other search engines. The software solution also remembers all search strings typed, result pages viewed, and all the external result links clicked on, along with the date and time at which these actions occurred. According to one embodiment of the present invention, the history of recent searches and clicks is displayed to the user along with the traditional search interface. According to another embodiment of the present invention, there is a helper application built into the software solution which tracks user interactions with any application, for example Active-X®, any web browser, for example Netscape® Navigator®, any system, for example UNIX®, and other software controls.

According to another embodiment of the present invention, a link to another page containing a more complete list of the user's search history is available, which allows the user to examine all the steps of a search along with information on all of the result links clicked on. On this page, the user is allowed to view and edit the list in various ways. For example, the user is offered a way to create an account on a system so that he/she may later re-visit a page or an entire site using the list of search history from the same or different computer and review the search behavior from previous sessions, or be able to add notes and ratings to each listing of a search history.

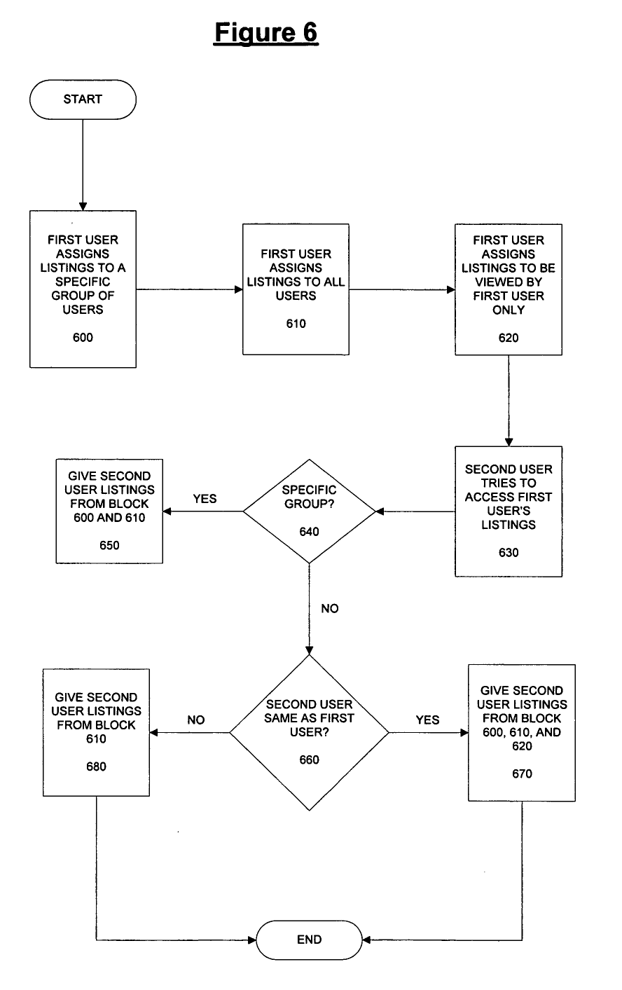

According to another embodiment of the present invention, the user has the ability to publish some or all of his/her list of search history along with any notes or ratings attached to each listing in a way that is viewable by other users. According to another embodiment of the present invention, some portions of a user's list of search history is viewable only by a specific group of other users, while the rest of the list is viewable by all users. The above embodiment is illustrated in FIG. 6, where at block 600 a first user assigns several listings in his/her search history to be viewable by only a specific group of other users on a system. At block 610, the user assigns several other listings different from the ones in block 600 to be viewable by all users of the system. At block 620, the user assigns the remaining listings (different from those in block 600 or 610) to be viewable by the user only. In other words, all other users are blocked from viewing those listings. At block 630, a second user tries to view the search history of the first user. At block 640, a check is made to see if the second user belongs to the specific group. If the second user belongs to the specific group (the “yes” branch), then at block 650 the second user can view the listings assigned at blocks 600 and 610. If on the other hand the second user does not belong to the specific group of other users (the “no” branch), the another check is made at block 660 to see if the second user is the same as the first user. If the second user is the same as the first user (the “yes” branch), then at block 670 the second user can view the listings assigned at blocks 600, 610, and 620. If on the other hand the second user is not the same as the first user (the “no” branch), then at block 680 the second user can view the listings assigned at block 610 only.

According to another embodiment, the user has the ability to block temporarily or permanently any listing within a search history. If a listing is permamnently blocked then it will not be recorded in the list of search history in all subsequent Internet searches. According to another embodiment, the search history is contained in a remote database to remain accessible to the user at any time.

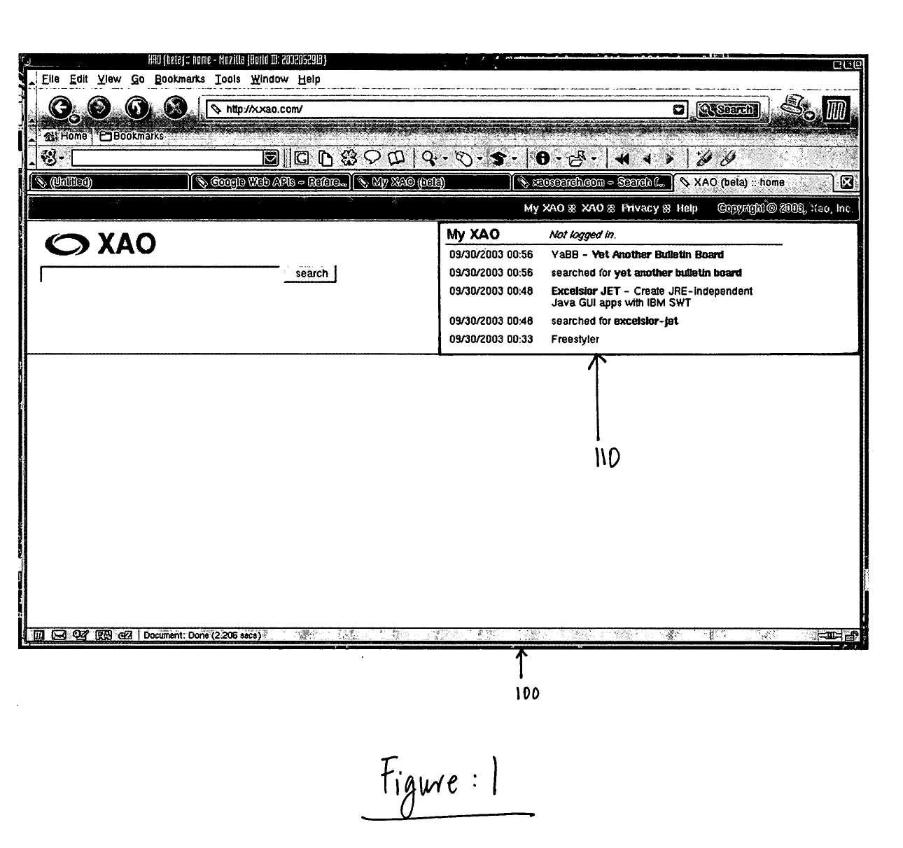

The software solution remembers all of the actions the user takes while searching, and allows the user to display or edit the results in a number of different ways. For example, the user can either immediately after the search activity add notes, publish or block certain listings as explained above, or at some other time in the future. Since most of the information collected during an Internet search is not stored on the local computer of the user, so it is extremely simple to review and edit search behaviors from multiple locations. The software solution allows a user to easily review and edit the history of a session, and to regain context at any time and from any location using any system or any web browser. FIG. 1 illustrates a snap shot view of the contents provided to a remote user who has used the software solution at least once before, according to one embodiment of the present invention. Item 100 is a screen shot of a user. The portion marked 110 is the recent history of the user showing not only the date and time of a recent search, but the relevant sites that were visited during those times and dates.

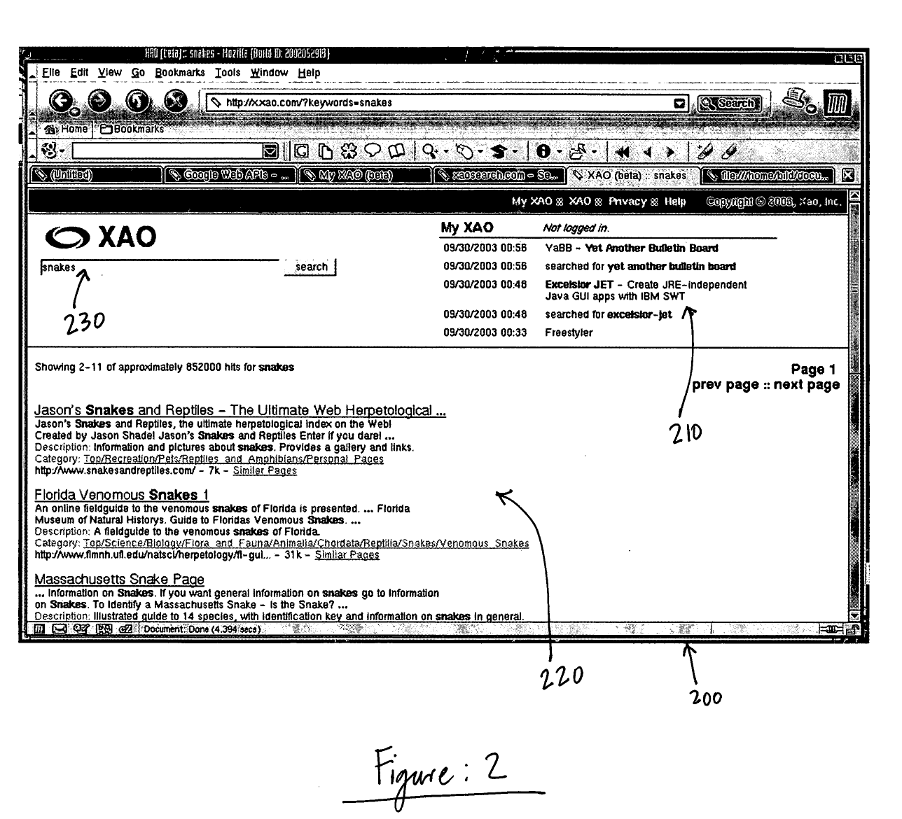

FIG. 2 illustrates a snap shot view of the contents provided to a user when a textual search of a listing is performed, according to another embodiment of the present invention. The user types the text in area marked 230. In the figure, the user is searching for “snakes”. The section marked 210 is the history of the user, and since the user in FIGS. 1 and 2 is the same, the contents of the history is also the same. The results of the search for “snakes” is displayed to the user in the section marked 220, which can be scrolled down to display the entire list, or can be displayed as per the preference chosen by the user (for example, display not more than 10 results per page; if more than 10 results, then display the remaining on subsequent page(s) following the same rule).

Cookie

One way to remember a user of the present invention is by presenting the browser of the user with a ‘cookie’, which is a small, randomly-generated tag used to identify a particular piece of browsing software on a specific system. Whenever the user enters a search string, or clicks on a search result, information about that search or click is saved in a remote database, along with the cookie, for later retrieval. As the user continues using the present invention, or when the user returns to the present invention at a later time, this cookie is used to retrieve the historical actions, some of which are displayed on the search screen itself.

The user can access a much larger list of his/her historical behavior on a separate page. This allows the user to view the list in different orders, delete histories from the list, re-visit those sites previously clicked on, or re-run previous searches. As explained earlier, the user has the ability to publish some or all of the search history listings to some, all, or no other users. The user may also use filters to automatically categorize or recognize as undesirable certain sites or search strings. As explained earlier, the user has the ability to permanently or temporarily block certain listings in the search history.

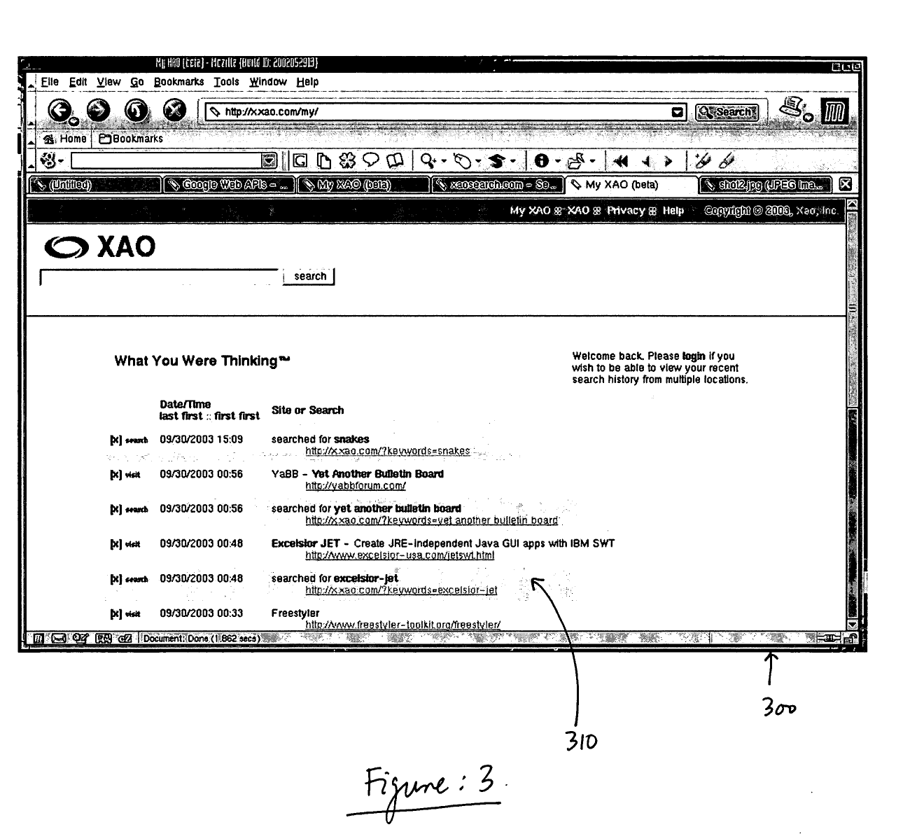

FIG. 3 illustrates a snap shot view of a user's history page, according to another embodiment of the present invention. The section marked 310 on display page 300 is where the history of the user is displayed. The history is divided into various columns such as date and time of the site or search, the site or search mechanism performed at a given date and time, and whether the user only visited the site or performed a search. It should be noted here that FIG. 3 is just an illustration of the listing of search history. The history could have more or less columns than shown in the figure depending on the preference of the user without departing from the essence of the present invention.

Remote Access

A mechanism can be added whereby a user can create an account by providing a unique username and password. This unique information can be stored in a database, and associated with the cookie and any other identifying information and history about the user. If the user later logs using the same or different system and provides the correct username and password, the new location will also be assigned the same identifying information, and the user will have access to his/her previous history from other sessions. The identifying information and other transaction logs may be encrypted or otherwise maintained in such a way that the inventing company of the system or their licensees may be unable to retrieve it independent of the user providing this information to them. Thus, a user's history will be stored indefinitely, and available to them whenever they return.

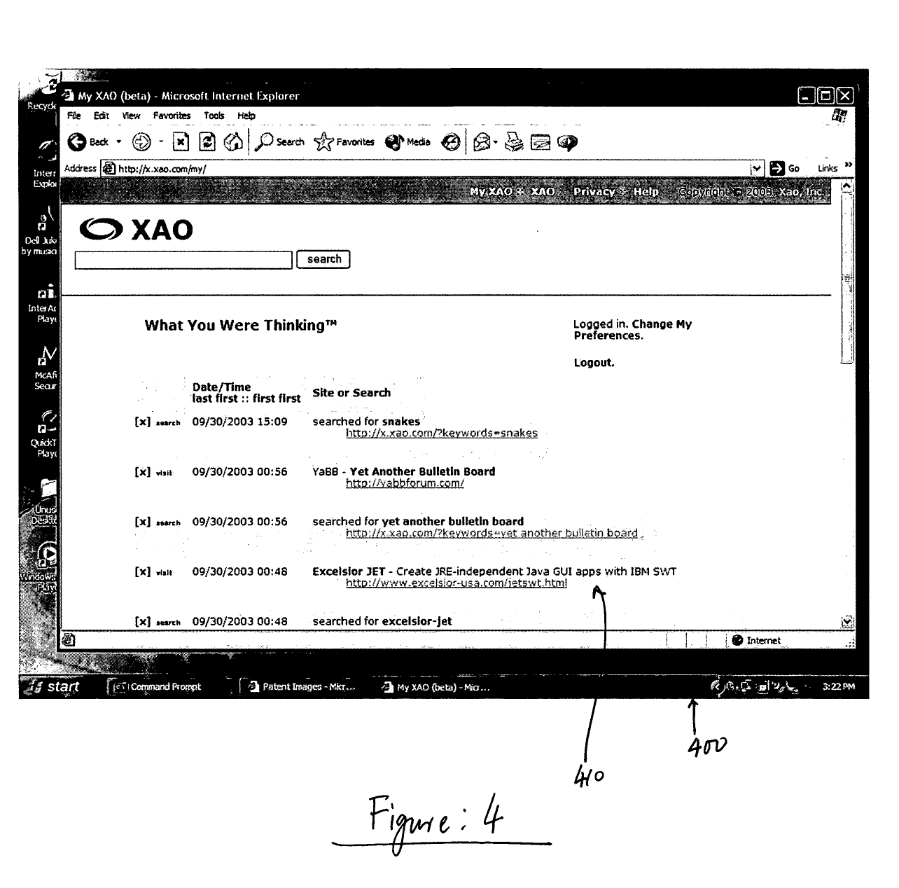

FIG. 4 is similar to FIG. 3 above, with the exception that the user is accessing the history via a system different than the one that generated the history. In other words, the user has moved to a location using a system to view and be able to access one or more of the sites visited by him/her during an earlier search using a different system. The section marked 410 on display page 400 is similar to section marked 310 on display page 300 of FIG. 3 above.

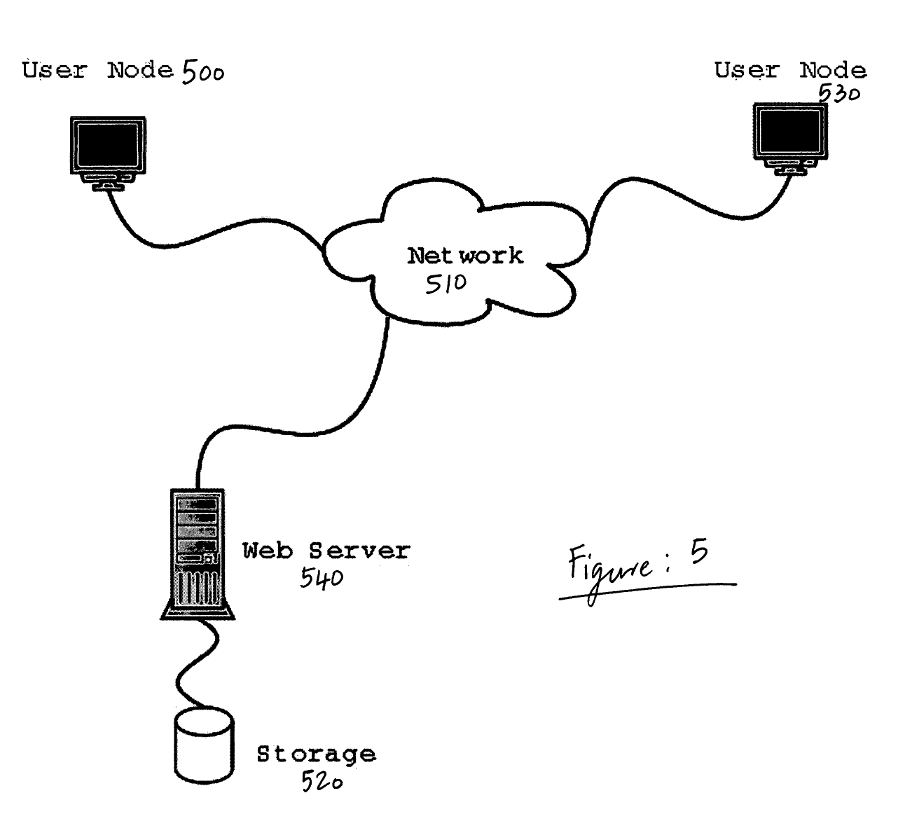

FIG. 5 illustrates the versatility of the present invention whereby a user can get access to the same history via two different systems and/or locations. User A accesses the network 510 via system (or node) 500. A cookie is set on the browser of the user and information about a search or click is saved in a remote database or storage 520 along with the cookie for future retrieval. When the same user moves to a different system or node, for example, node 530, the history of the user created when the user was on node 500 is retrieved from the storage location via a web server 540. Thus, the user never looses or has to remember the various sites visited on a previous search even when a different system, different web browser, or different application is used.

According to another embodiment of the present invention, the relevancy of the stored search results can be adjusted by accounting for the number of stored links for a site. The number of saved searches for a particular URL and a particular keyword can be used, for example, as a mark of relevancy. URLs that have more relevancy for a specific keyword search may be saved in the favorites area of the user as they are clicked on more frequently than less relevant URLs. In conjunction with the browser helper object, different weights can be assigned to different behaviors in determining relevancy. For example, searching for a term, or visiting the site and then saving a page locally will indicate a higher degree of relevancy than simply a search result that is visited.

Helper Application

According to another embodiment, the universal state of a user is maintained such that all user behavior is tracked. User behavior could include searching the Internet, purchasing products, and other online actions. These behaviors are monitored via a helper application that may reside within the browser, or as a standalone application. The history of a user may be stored locally (local history), but can also be stored remotely. When stored remotely, the user logs using a username/password combination as explained earlier to view his/her history. According to another embodiment, a similar helper application may be built into the software solution that tracks user interactions with any application, any web-browser, any system, or other software controls, allowing the history of a user's activity on that system to be maintained, browsed, searched, and presented to the user for editing, much as the web browsing history would be. This local history may also be exported to a remote server, which allows the user to view this activity from other locations.

According to another embodiment of the present invention, the storage of individual web pages is based on a user's input. In operation, a user surfing the web runs the software solution allowing the user to save individual files, complete pages, or perhaps even snapshots of part or all of a website. The files, pages, and websites are then stored locally, in a remote location, or sometimes in both places. The user can then login and review that information at a later time. According to another embodiment, the user is capable of searching through this information, or displaying the stored pages that contain the particular bits of interest. According to another embodiment, an additional feature notifies the user if the stored information they are viewing has been updated on the original site, or has otherwise changed.

According to another embodiment, the relevancy of the search results are adjusted based on the stored web pages in the profile of a user. These web pages are usually stored in a central database and represent the highest level of interest to a user. Therefore, based on the aggregate behavior of a plurality of users, the saved web pages represent the highest interest of a group of users. By applying psychographic and demographic data to a users' profile and stored pages, advertising can be narrowly focused and sent to the user searching the Internet using the present invention.

According to another embodiment, the user is able to add notes and ratings to each listing in his/her search history. As explained earlier, the user may choose to make public or leave as private some or all of the listings in a search history. A user also has the ability to manually add listings to the history without having to search for or click on a particular listing. According to another embodiment of the present invention, an auto-categorization interface allows a user to present the option of grouping the history listings together based on various criteria other than time and date clicked.

Thus, a method for storing search and results on the Internet is described in conjunction with one or more specific embodiments. The present invention is defined by the following claims and their full scope of equivalents.

1. A method to maintain a record of search results on the Internet, comprising:
recording every search string typed by a user, every result page viewed by said user and every external result links clicked by said user as a listing in a search history; and
displaying said search history to said user along with an interface.

2. The method of claim 1 wherein said search history further comprises:
a date and a time when a search was performed by said user;
a search mechanism performed at said date and time; and
an indication if said user only visited a site or also performed said search.

3. The method of claim 1 wherein said interface is a link to a page containing a more complete listing of said search history.

4. The method of claim 1 wherein said every search string typed by said user, every result page viewed by said user and every external result links clicked by said user is saved along with a cookie in a remote database.

5. The method of claim 1 to maintain said record further comprises:
allowing said user to view said listing in an order;
allowing said user to delete one or more search histories from said record;
allowing said user to re-visit a result page viewed or an external results link clicked;
allowing a user to re-run a previous search; and
notifying a user to update a listing in said record.

6. The method of claim 5 wherein said order is either ascending or descending.

7. A method to manipulate a record of search results, comprising:
allowing a user to create an account on a system;
allowing said user to add notes and ratings to each listing of said search results;
allowing said user to publish some or all of said listing along with said notes and ratings to a plurality of other users;
adjusting the relevancy of said record; and
allowing a user to manually add one or more listings to said record.

8. The method of claim 7 wherein said account is generated by said user supplying a unique username and password combination.

9. The method of claim 8 wherein said unique username and password combination is encrypted.

10. The method of claim 7 wherein said plurality of other users comprises users of a specific group.

11. The method of claim 7 wherein said user can block temporarily or permanently each listing in said search results.

12. The method of claim 7 to manipulate said record can be performed on all current systems using any one of plurality of current web-browsers.

13. The method of claim 7 further comprises allowing said user to automatically categorize or recognize as undesirable certain result page viewed, or external results link clicked.

14. The method of claim 7 wherein said adjusting is performed using a number of saved searches for a particular URL and a particular keyword.
